(19) United States
(12) Patent Application Publication
(10) Pub. No.: US 2013/0080733 A1
(43) Pub. Date: Mar. 28, 2013

(54) PROCESSOR AND CONTROL METHOD OF PROCESSOR

(71) Applicant: Masaharu MARUYAMA, Kawasaki (JP)

(72) Inventor: Masaharu MARUYAMA, Kawasaki (JP)

(73) Assignee: FUJITSU LIMITED, Kawasaki-shi (JP)

(21) Appl. No.: 13/552,820

(22) Filed: Jul. 19, 2012

(30) Foreign Application Priority Data
Sep. 22, 2011 (JP) 2011-207541

(51) Int. Cl. G06F 12/10

(52) U.S. Cl. 711/207; 711/E12.061

(57) ABSTRACT

A processor connected to a storage device including a buffer area where an address translation pair is stored includes: an LRU register that holds a number of a plurality of real address registers, the real address register being the oldest in a use history; a reading unit that reads the number of the real address register held in the LRU register when a real address included in an access request to the storage device does not fall within a range of a real address space from a lower limit real address held in a lower limit real address register to an upper limit real address held in an upper limit real address register; and a setting unit that invalidates the real address register corresponding to the read number and sets a real address space corresponding to the real address included in the access request to the invalided real address register.

### CROSS-REFERENCE TO RELATED APPLICATION

This application is based upon and claims the benefit of priority of the prior Japanese Patent Application No. 2011-207541, filed on Sep. 22, 2011, the entire contents of which are incorporated herein by reference.

### FIELD

The present embodiment relates to a processor and a control method of a processor.

### BACKGROUND

There has been a computing machine virtualization technique of operating a plurality of virtual machines each being a virtual computing machine simultaneously. In order to achieve the virtualization of a computing machine, address translation is performed. The address translation is a necessary function of a computing machine on the premise of an operating system (referred to as an OS, hereinafter) provided with a multitasking function. The address translation is to translate a virtual address in a virtual address space where a program operates into a physical address in a memory space of a computing machine. In the address translation by paging, which has been employed in most computing machine architectures currently, a high-order bit of the virtual address determined according to a page size is translated into a value corresponding to the physical address. The address translation processing is associated with all memory access operations, and thus is needed to be executed at a high speed, and by a CPU (Central Processing Unit) including a buffer memory, called a TLB (Translation Lookaside Buffer), storing an address translation pair of the virtual address and the physical address, hardware performs the processing.

There has been known a TLB virtualization method of a machine virtualization device, in which a hypervisor (Hypervisor) is executed on a real machine, an OS is operated on a plurality of virtual machines generated by processing by the hypervisor, and TLB entry calculation is performed using RID (Region Identifier) values identifying virtual address spaces assigned to each process on the virtual machines by processing of the hypervisor (see Patent Document 1, for example). Here, by processing of the hypervisor, the RID values on the virtual machines used for the TLB entry calculation on the real machine are translated into different values in the plural virtual machines, and further values of bit strings of the translated RID values are changed.

[Patent Document 1] Japanese Laid-open

Patent Publication No. 2009-146344

### SUMMARY

A processor connected to a storage device including a buffer area where an address translation pair of which a virtual address and a real address are made to correspond is stored, the processor includes: a real address register set that includes: a plurality of real address registers including: a lower limit real address register holding a lower limit real address of a plurality of real address spaces set in the storage device; and an upper limit real address register holding an upper limit real address of the plurality of real address spaces and holding a real address; an LRU register that holds a number of the real address register being the oldest in a use history of the plurality of real address registers; a reading unit that reads the number of the real address register held in the LRU register when a real address included in an access request to the storage device does not fall within a range of a real address space from the lower limit real address held in the lower limit real address register to the upper limit real address held in the upper limit real address register; and a setting unit that invalidates the real address register corresponding to the read number and sets a real address space corresponding to the real address included in the access request to the invalided real address register.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a configuration example of a processor according to an embodiment;

FIG. 2 is a diagram depicting a configuration example of an address translation buffer;

FIG. 3 is a view depicting an address space example of a main memory;

FIG. 4 is a flowchart depicting a processing example of the processor according to a reference technique;

FIG. 5 is a flowchart depicting a processing example of the processor according to this embodiment;

FIG. 6 is a diagram depicting a configuration example of the processor including a hardware table walker; and

FIG. 7 is a view depicting a specific configuration example of a part of the hardware table walker in FIG. 6.

### DESCRIPTION OF EMBODIMENTS

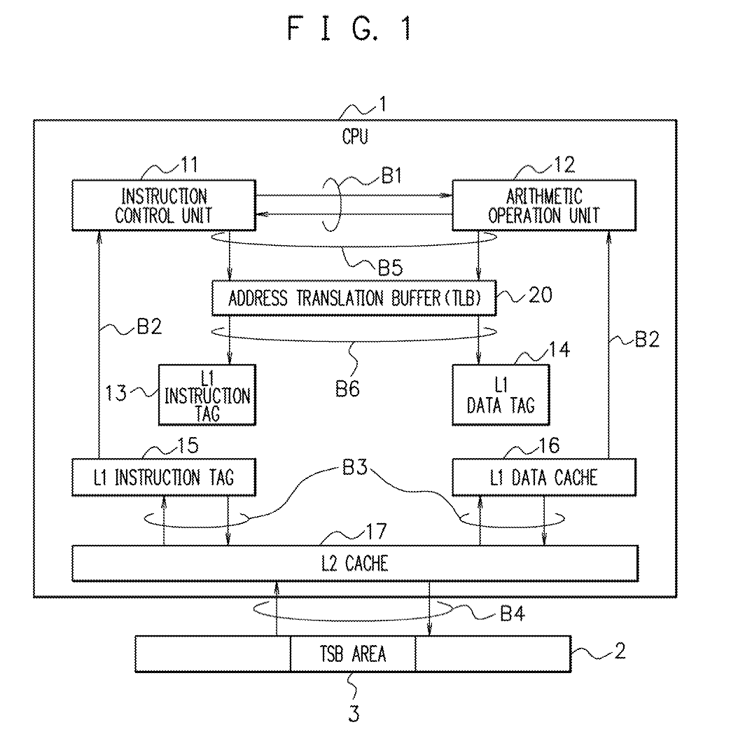

FIG. 1 is a diagram depicting a configuration example of a processor 1 according to an embodiment. Incidentally, in FIG. 1, some of components configuring the processor 1 are merely extracted and illustrated. The processor 1 is a central processing unit (CPU), for example. The processor 1 includes: therein an instruction control unit 11; an arithmetic operation unit 12; an L1 instruction tag 13; an L1 data tag 14; an L1 instruction cache 15; an L1 data cache 16; an L2 cache 17; and an address translation buffer (TLB) 20.

The processor 1 performs an arithmetic operation in accordance with an instruction stored in a storage device provided in a computer, and processes information in accordance with a result of the arithmetic operation. Here, the “instruction” means an instruction included in an instruction set that can be executed by the processor 1.

The instruction control unit 11 controls the flow of processing executed by the processor 1. Specifically, the instruction control unit 11 reads an instruction to be processed in the processor 1 from the storage device and decodes the instruction to transmit a result of the decoding to the arithmetic operation unit 12 (see B1 in FIG. 1). The arithmetic operation unit 12 is a processing unit where an arithmetic operation is performed. Specifically, the arithmetic operation unit 12 reads data to be an object for the instruction from a storage device and arithmetically operates the data in accordance with the instruction decoded by a non-depicted instruction decoder included in the instruction control unit 11 to transmit a result of the arithmetic operation to the instruction control unit 12 (see B1 in FIG. 1).

The instruction control unit 11 and the arithmetic operation unit 12 read the instructions and data from the storage devices including a main memory 2 and cache memories. Examples of the cache memories include a primary (Level 1) cache (that will be an L1 cache, hereinafter), a secondary (Level 2) cache (that will be an L2 cache, hereinafter), and so on. Normally, these cache memories are hierarchically provided in the processor 1. In the processor 1 illustrated in FIG. 1, the L1 instruction cache 15 being an L1 cache dedicated to instructions and the L1 data cache 16 being an L1 cache dedicated to data are provided as the L1 cache. Further, as the L2 cache, the L2 cache 17 is provided. The main memory 2 is connected to the processor 1 and is provided outside the processor 1 as one of the storage devices.

The L1 instruction cache 15 and the L1 data cache 16 can operate with the same clock as that with the processor 1, and can respond to requests given from the instruction control unit 11 and the arithmetic operation unit 12 at a high speed (see B2 in FIG. 1). However, in many cases, the capacities of the L1 instruction cache 15 and the L1 data cache 16 are about 32 K to 128 KB in total, thus making it impossible to store a lot of information. For this reason, the L2 cache 17 comes to store frequently-used pieces of information among pieces of information that are not allowed to be stored in the L1 instruction cache 15 and the L1 data cache 16 (see B3 in FIG. 1). Incidentally, the information that is not allowed to be stored in the L2 cache 17 is stored in the main memory 2 (see B4 in FIG. 1). The cache memories 15 to 17 store some of the information stored in the main memory 2.

At the time when the instruction control unit 11 and the arithmetic operation unit 12 start processing, instructions and data have existed in the main memory 2, and nothing has been stored in the L1 instruction cache 15, the L1 data cache 16, or the L2 cache 17. When the instruction control unit 11 and the arithmetic operation unit 12 read an instruction and data from the main memory 2, the instruction and data are loaded to the L1 instruction cache 15, the L1 data cache 16, or the L2 cache 17. After the loading, the instruction control unit 11 and the arithmetic operation unit 12 read the instruction and data not from the low-speed main memory 2 but from the high-speed L1 instruction cache 15, L1 data cache 16, or L2 cache 17.

In other words, the instruction and data that the instruction control unit 11 and the arithmetic operation unit 12 intend to read have not always been stored in the L1 instruction cache 15 and the L1 data cache 16. For this reason, the L1 instruction tag 13 and the L1 data tag 14 are utilized by the instruction control unit 11 and the arithmetic operation unit 12 instead. That is, when the instruction and data are loaded to the L1 instruction cache 15 and the L1 data cache 16, information indicating at which addresses of the main memory 2 these instruction and data are stored is simultaneously set in the L1 instruction tag 13 and the L1 data tag 14. Thus, when reading the instruction and data, the instruction control unit 11 and the arithmetic operation unit 12 first send inquiries to the L1 instruction tag 13 and the L1 data tag 14 and check whether or not the instruction and data to be read have been stored in the L1 instruction cache 15 and the L1 data cache 16.

A virtual storage method is applied to the processor 1. The address translation buffer 20 stores address translation pairs each of which a virtual address (Virtual Address) VA and a physical address (Physical Address) PA are made to correspond. The virtual address VA is the virtually provided address architecture enabling access protection in units of a page. The physical address PA is an address to be used when actually accessing the main memory 2. When reading the instruction and data, the instruction control unit 11 and the arithmetic operation unit 12 first designate a virtual address to the address translation buffer 20 (see B5 in FIG. 1), and the address translation buffer 20 translates the virtual address into a physical address, and then the instruction control unit 11 and the arithmetic operation unit 12 send inquiries to the L1 instruction tag 13 and the L1 data tag 14 (see B6 in FIG. 1).

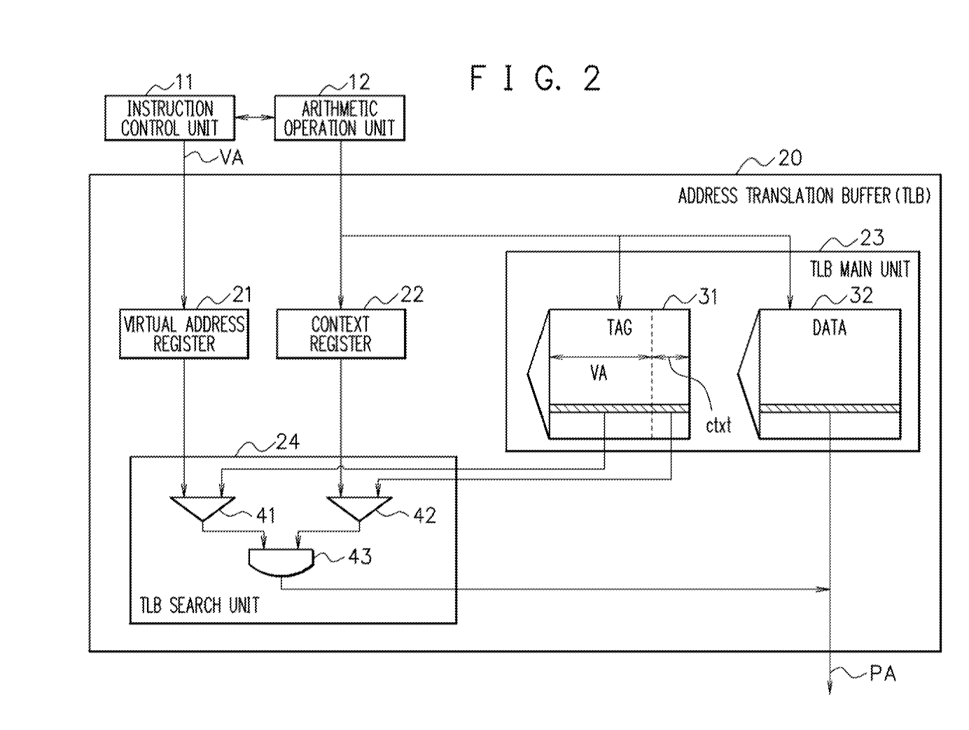

FIG. 2 is a view depicting a configuration example of the address translation buffer 20. The configuration of the address translation buffer 20 will be explained. As depicted in FIG. 2, the address translation buffer 20 includes: therein a virtual address register 21; a context register 22; a TLB main unit 23; and a TLB search unit 24.

The virtual address register 21 is a register that holds the virtual address VA output from the instruction control unit 11. The context register 22 is a register that holds a context output from the arithmetic operation unit 12. The context is information used to specify the process of an application from which the instruction is issued.

The TLB main unit 23 includes a tag unit 31 and a data unit 32. The tag unit 31 holds the virtual addresses VA and contexts ctxt as entries. The virtual address VA and the context ctxt are used as tags for search. Further, the data unit 32 holds the address translation pairs each of which the virtual address VA and the physical address PA are made to correspond as entries.

The TLB search unit 24 will be explained. The TLB search unit 24 determines whether or not a combination of the virtual address VA held in the virtual address register 21 and the value in the context register 22 matches a combination of the virtual address VA and the value of the context ctxt that are registered in the tag unit 31.

A comparison circuit 41 in the TLB search unit 24 compares the virtual address VA held in the virtual address register 21 and the virtual address VA registered in the tag unit 31 and outputs a result of the comparison to a logical product (AND) circuit 43. Similarly, a comparison circuit 42 in the TLB search unit 24 compares the context held in the context register 22 and the context ctxt registered in the tag unit 31 and outputs a result of the comparison to the logical product circuit 43. When the virtual addresses VA in the virtual address register 21 and the tag unit 31 are matched and the context in the context register 22 and the context ctxt in the tag unit 31 are matched, the AND circuit 43 outputs a value indicating a TLB hit. Incidentally, the reason why the matching of the context and the context ctxt is needed in addition to the matching of the virtual addresses VA is because the virtual addresses VA used in different processes may be matched unexpectedly.

When the TLB search unit 24 has output a TLB hit, the address translation buffer 20 fetches the physical address PA corresponding to the virtual address VA from the data unit 32 to output it. On the other hand, when the TLB search unit 24 has not output a TLB hit, namely has output a value corresponding to a TLB miss, the instruction control unit 11 refers to a page table stored in a TSB (translation storage buffer: Translation Storage Buffer) area 3 in the main memory 2 to acquire an address translation pair corresponding to the virtual address VA and sends the acquired address translation pair to the arithmetic operation unit 12. The arithmetic operation unit 12 registers the received address translation pair and the context indicating the process in execution in the TLB main unit 23. Thereafter, the instruction control unit 11 executes the instruction again to translate the virtual address VA into the physical address PA using the address translation pair registered in the address translation buffer 20.

The “virtual storage method” is a technique that makes a memory capacity larger than a memory capacity actually mounted in a computer appear to be provided in the computer by using an external storage device (a hard disk device or the like) as a swap area of the main memory 2. That is, the “virtual storage method” is to, when the memory capacity becomes insufficient, temporarily swap less-frequently-used information among pieces of information in the main memory 2 to a swap area that has been secured in the hard disk device by an OS in advance, thereby compensating for the insufficiency of the memory capacity temporarily.

In the “virtual storage method” as above, two addresses of the “virtual address VA” and the “physical address PA” are used. When an application side performs reading and writing (memory access) from and to the main memory 2, the virtual address VA is used. In contrast to this, an address given to an element of the main memory 2 is the physical address PA. For the purpose of translating the virtual address VA into the physical address PA, the computer employing the virtual storage method stores a list (referred to as a “page table” hereinafter) of address translation pairs each for translating the virtual address VA into the physical address PA (TTE (Translation Table Entry)).

The page table is normally stored in the TSB area 3 of the main memory 2, but if the processor 1 refers to the page table stored in the main memory 2 every time the translation from the virtual address VA into the physical address PA is needed, the access to the main memory 2 from the processor 1 has to be slow, and thus an enormous amount of time is to be spent on the translation. In order to avoid this, the address translation buffer 20 is provided in the processor 1, and the address translation buffer 20 stores some of the address translation pairs of the page table stored in the TSB area 3.

The case when the processor 1 performs reading and writing (memory access) from and to the main memory 2 by the application will be explained. First, the processor 1 has the predetermined virtual address VA designated by the OS. Subsequently, the processor 1 searches the address translation buffer 20 according to the predetermined virtual address VA designated by the OS, and when the processor 1 fails in the search, a TLB miss occurs. When such a TLB miss occurs, a TLB miss trap occurs, and thus the processor 1 reports the occurrence of this TLB miss trap to the OS, and the OS that has received the report performs trap processing with respect to the processor 1. The processor 1 checks whether or not the address translation pair connected to the predetermined virtual address VA (the address translation pair of the physical address PA corresponding to the predetermined virtual address VA) is stored in the cache memories 15 to 17 as the trap processing. When the address translation pair is stored, the processor 1 registers the stored address translation pair in the address translation buffer 20, and when the address translation pair is not stored, the processor 1 acquires the address translation pair from the TSB area 3 to once store it in the cache memories 15 to 17, and then registers it in the address translation buffer 20. In this way, when the processor 1 performs the search in the address translation buffer 20 according to the predetermined virtual address VA, which has caused a TLB miss, again, the processor 1 does not fail in the search this time, and a TLB hit is made.

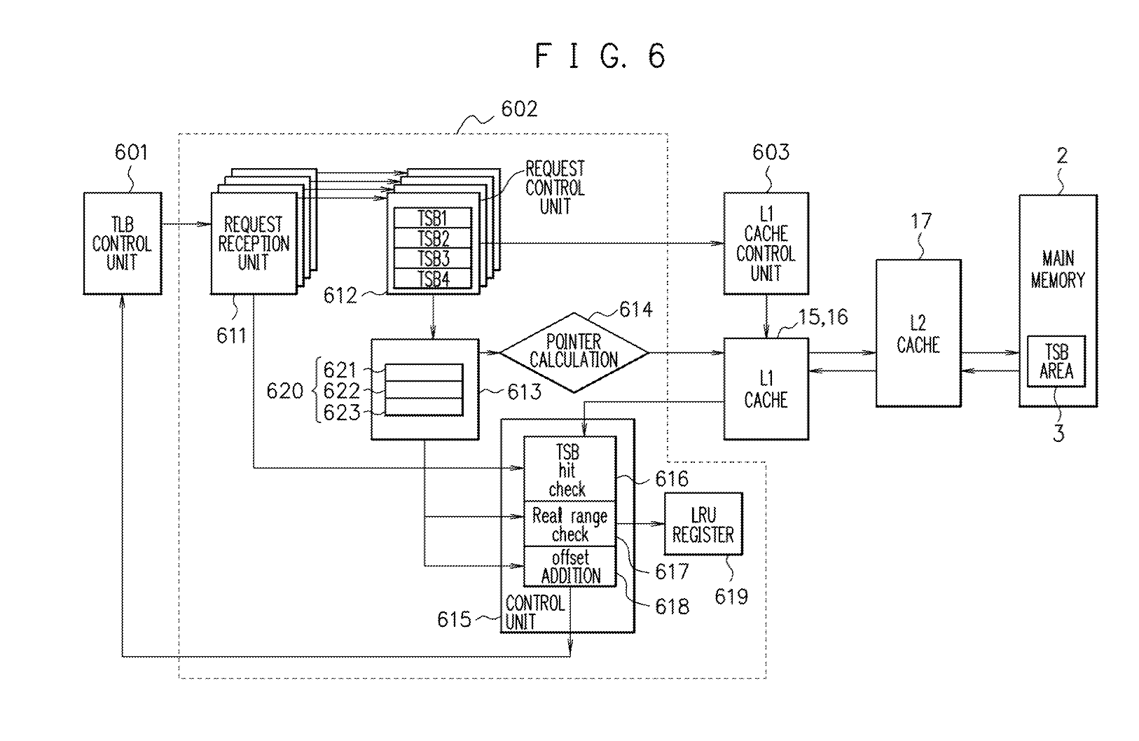

The processor 1 uses a hardware virtualization technique in order to effectively utilize limited computing machine resources. In the hardware virtualization, the OS operates on a hypervisor. The memory management is performed by the hypervisor, and thus when the TLB miss trap processing occurs, not only the OS, but also the hypervisor performs the above-described processing. Thus, an overhead is further increased. Further, when the TLB miss trap processing occurs in the plurality of OSs on the hypervisor, a load on the hypervisor is increased and a penalty for the TLB miss trap processing is further increased. Then, in place of the trap processing being performed by the OS and the hypervisor, a hardware table walker 602 (FIG. 6) in which hardware for itself fetches the entry that has caused a TLB miss from the TSB area 3 in the main memory 2 and registers it in the address translation buffer 20 automatically is used. The hardware table walker 602 is hardware provided in the processor 1.

When detecting a TLB miss, the processor 1 activates the hardware table walker 602 in place of reporting the trap to the OS. The hardware table walker 602 fetches the address translation pair that has caused a TLB miss from the TSB area 3 in the main memory 2 to check that the fetched address translation pair is the necessary address translation pair, and performs a check whether a real address (Real Address) RA falls within a predetermined range, and the like. Here the real address RA is a physical address on the main memory 2 that has been virtualized for a virtual machine by the hypervisor. When the real address RA falls within the predetermined range, the hardware table walker 602 translates the real address RA into the physical address PA and registers an address translation pair of the virtual address VA and the physical address PA in the address translation buffer 20, and then makes the request that has caused a TLB miss to the main memory 2 again and continues the operation at a high speed without the trap processing. When the trap processing has been performed, requests subsequent to the request made again are all once cancelled to then be executed again after the trap is completed, but when the hardware table walker 602 is activated, the above process is not needed, resulting in that the subsequent requests become executable immediately and no penalty for the cancellation is also caused.

In a virtual machine, when performing the address translation, a virtualized guest OS (supervisor) performs the translation from the virtual address VA into the real address RA. The translation from the real address RA into the physical address PA is managed by the hypervisor. The hypervisor translates the real address RA into the physical address PA using a real address register set 620 (FIG. 6).

As depicted in FIG. 6, the real address register set 620 is a register set composed of three registers of a lower limit real address register 621, an upper limit real address register 622, and an offset register 623 set as one set. The lower limit real address register 621 stores a lower limit address of a real address space. The upper limit real address register 622 stores an upper limit address of the real address space. The offset register 623 stores an offset address for translating the real address RA into the physical address PA. This offset address is added to the real address RA, and thereby the physical address PA can be calculated.

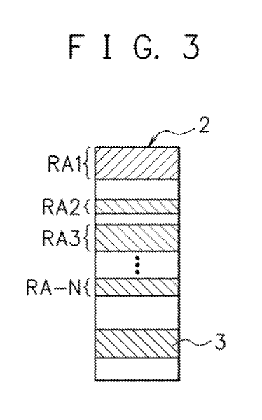

FIG. 3 is a view depicting an address space example of the main memory 2. The main memory 2 has a plurality of real address spaces RA1 to RA-N (N is a natural number) and the TSB area 3. A lower limit value and an upper limit value of each of the real address spaces RA1 to RA-N are defined by the above-described real address register set 620. That is, the lower limit real address register 621 in the real address register set 620 stores a lower limit real address of a real address space set in the main memory 2, and the upper limit real address register 622 in the real address register set 620 stores an upper limit real address of the real address space set in the main memory 2. The hypervisor can assign N pieces of the real address spaces RA1 to RA-N to the physical address PA. When the real address spaces more than N pieces of the real address spaces are needed, the real address space old in a use history is once made unusable and the real address space is newly assigned. In N pieces of the real address spaces RA1 to RA-N, N sets of the real address register sets 620 are provided. The TSB area 3 stores address translation pairs, each of which the virtual address VA and the real address RA are made to correspond.

The hardware table walker 602 checks N sets of the real address register sets 620 prepared by the hypervisor, and when the real address RA of an entry (the address translation pair of the virtual address VA and the real address RA) fetched from the TSB area 3 in the main memory 2 falls within the range of the real address spaces designated by the lower limit real address registers 621 and the upper limit real address registers 622 of N sets of the real address register sets 620, the hardware table walker 602 uses the offset address of the offset register 623 of the real address register set 620 and adds this offset address to the real address RA to calculate the physical address PA, and then registers the address translation pair of the virtual address VA and the physical address PA in the address translation buffer 20.

As described above, through N sets of the real address register sets 620, the hypervisor assigns N pieces of the usable real address spaces RA1 to RA-N to the physical address PA. When assigning the real address spaces more than N pieces of the real address spaces to the physical address PA, the hypervisor invalidates one of N pieces of the already assigned real address spaces and newly assigns the N+1th real address space there instead. Such replacement of the real address spaces causes a very large penalty, so that there is a challenge that N pieces of the real address spaces are desired to be used as efficiency as possible. However, the hypervisor has no way of knowing which of N pieces of the real address spaces RA1 to RA-N the hardware uses frequently to thus need to replace the real address spaces in FIFO (first-in-first-out) order or the like. In that case, a kernel area that is constantly used by the OS for the trap processing and the like is once driven out of the real address space at the rate of once in N times eventually. The real address space of which the kernel area has been driven out is needed again immediately, so that the real address space is needed to be taken again, but wasteful replacement processing of the real address spaces occurs to thus cause remarkable performance deterioration.

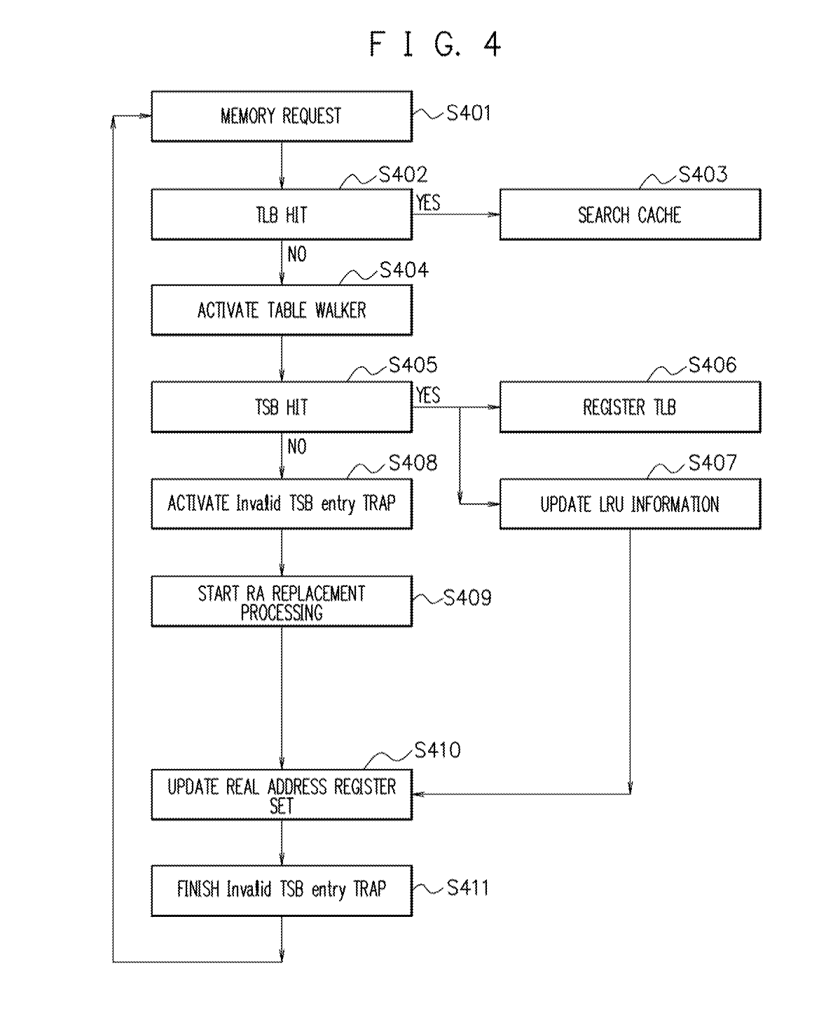

FIG. 4 is a flowchart depicting a processing example of the processor 1 by a reference technique. At Step S401, the processor 1 inputs a reading and writing (memory access) request in the main memory 2 by the application.

Then, at Step S402, the processor 1 has the predetermined virtual address VA designated by the OS. Subsequently, the processor 1 searches the address translation buffer 20 for the address translation pair of the virtual address VA designated by the OS. When succeeding in the search, the processor 1 proceeds to Step S403 as a TLB hit, and when failing in the search, the processor 1 proceeds to Step S404 as a TLB miss. Specifically, when the address translation pair of the virtual address VA corresponding to the access request to the main memory 2 exists in the address translation buffer 20, a TLB hit is made, and when it does not exist in the address translation buffer 20, a TLB miss is made.

At Step S403, when the address translation buffer 20 translates the virtual address VA into the physical address PA, an access unit in the processor 1 gives an inquiry to the L1 instruction tag 13 and the L1 data tag 14 and makes instruction and data access to the L1 instruction cache 15 and the L1 data cache 16. Specifically, when the address translation pair of the virtual address VA corresponding to the access request to the main memory 2 at Step S401 exists in the address translation buffer 20, the access unit in the processor 1 uses the physical address PA translated according to the address translation pair to access the cache memories 15 to 17.

At Step S404, when detecting a TLB miss, the processor 1 activates the hardware table walker 602. The hardware table walker 602 searches the TSB area 3 of the main memory 2 for the address translation pair of the virtual address VA that has caused a TLB miss. Specifically, the hardware table walker 602 checks whether or not the real address RA corresponding to the virtual address VA falls within the range of the real address spaces of N sets of the existing real address register sets 620.

Next, at Step S405, the processor 1 proceeds to Steps S406 and S407 as a TSB hit when the real address RA falls within the range of the above-described real address spaces, and the processor 1 proceeds to Step S408 as a TSB miss when the real address RA does not fall within the range. Specifically, when the real address RA corresponding to the access request to the main memory 2 at Step S401 falls within the range of the real address spaces set by N sets of the real address register sets 620, a TSB hit is made, and when it does not fall within the range, a TSB miss is made.

At Step S406, the processor 1 translates the above-described real address RA into the physical address PA, registers the address translation pair of the virtual address VA and the physical address PA in the address translation buffer 20, and makes the request that has caused a TLB miss to the main memory 2 again to make instruction and data access to the L1 instruction cache 15 and the L1 data cache 16. Specifically, when the real address RA corresponding to the access request to the main memory 2 at Step S401 falls within the range of the real address spaces set by N sets of the real address register sets 620, an address translation buffer register unit in the processor 1 generates an address translation pair of the virtual address VA and the physical address PA based on the address translation pair corresponding to the real address RA in the TSB area 3 to register it in the address translation buffer 20.

At Step S407, the processor 1, with the above-described registration, updates the number of the real address register set 620 being the oldest in the use history of N sets of the real address register sets 620 as LRU (Least Recently Used) information.

At Step S408, the processor 1 reports the occurrence of an invalid TSB entry trap to the OS, and the OS that has received the report activates invalid TSB entry trap processing with respect to the processor 1.

Next, at Step S409, the processor 1 starts the replacement processing of the real address spaces.

Next, at Step S410, the processor 1 updates the real address register set 620 to thereby perform the replacement of the real address spaces. Specifically, the processor 1 makes the oldest real address space indicated by the LRU information unusable once to then newly assign the real address space.

Next, at Step S411, the processor 1 finishes the invalid TSB entry trap processing to return to Step S401.

Here, the problem of the processing in FIG. 4 will be explained. The case when while the real address register set 620 being updated at Step S410, the LRU information is updated at Step S407 will be explained. For example, it is assumed that at Step S407, the value of the LRU information has been changed to the number 3 from the number 2 in terms of the number of the real address space. In the case, there is sometimes a case that at Step S410, in the same real address register set 620, the lower limit real address of the real address space corresponding to the number 2 is recorded in the lower limit real address register 621, and the upper limit real address of the real address space corresponding to the number 3 is recorded in the upper limit real address register 622. In such a case, the update of the correct real address register set 620 is not performed to thus cause a malfunction.

That is, when the LRU information has been updated while a store instruction to update the three registers 621 to 623 in the real address register set 620 is being executed, the register corresponding to a wrong number is updated to thus cause a malfunction.

For avoiding this, it is considered that management to prevent the LRU information from being updated is performed by the hypervisor while the store instruction to update the three registers 621 to 623 in the real address register set 620 is being executed. The hardware table walker 602 is not operated during this period in the processor 1 with in-order execution, so that no problem is caused even though the above-described operation is executed. Incidentally, the in-order execution is to sequentially execute instructions in the order as described in the program. However, in the case when the hardware table walker 602 is activated with out-of-order execution, while the three registers 621 to 623 in the real address register set 620 are being updated, the LRU information is updated by the hardware table walker 602 in operation to thereby cause a problem that the register corresponding to a wrong number is eventually updated as described above. Incidentally, the out-of-order execution is to execute instructions in a manner to change the order of the instructions that is described in the program. Then, there will be explained an embodiment that can operate correctly even with out-of-order execution below.

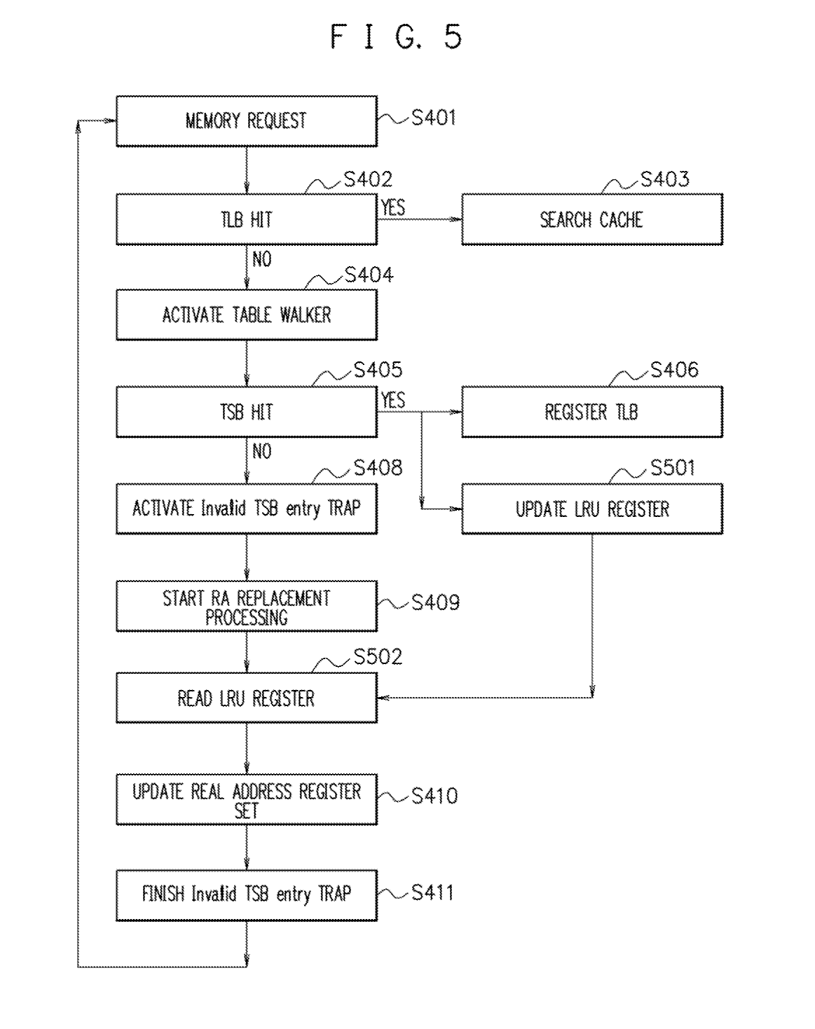

FIG. 5 is a flowchart depicting a processing example of the processor 1 according to this embodiment. The flowchart in FIG. 5 is one in which in and to the flowchart in FIG. 4, Step S501 is provided in place of Step S407 and Step S502 is added. Hereinafter, the point of which the flowchart in FIG. 5 is different from the flowchart in FIG. 4 will be explained.

At Step S405, when a TSB hit is made, the processor 1 proceeds to Steps S406 and S501. At Step S501, an LRU register update unit in the processor 1 updates an LRU register 619 (FIG. 6) by the hardware table walker 602. Specifically, when the real address RA corresponding to the access request to the main memory 2 at Step S401 falls within the range of the real address spaces set by N sets of the real address register sets 620, the LRU register update unit in the processor 1 updates the number to be stored in the LRU register 619 so that the use history of the real address register set 620 falling within the range becomes the latest.

In this embodiment, in the case of the real address space being newly assigned, in order to determine which of N sets of the real address register sets 620 to update, the LRU register 619 is newly prepared and a means that the hardware notifies the hypervisor of the LRU information regarding the usage status of the latest real address space is provided. If there are the unused real address register sets 620 among N sets of the real address register sets 620, the LRU register 619 stores the smallest number of the real address register set 620 of the unused real address register sets 620, and if N sets of the real address register sets 620 are all used, the LRU register 619 stores the number of the real address register set 620 being the oldest in the use history of the hardware table walker 602 of N sets of the real address register sets 620.

After Step S409, at Step S502, in the case of the real address space being newly assigned by the instruction of the hypervisor, a reading unit in the processor 1 first reads a value of the LRU register 619. That is, when the real address RA corresponding to the access request to the main memory 2 at Step S401 does not fall within the range of the real address spaces set by N sets of the real address register sets 620, the reading unit in the processor 1 reads the number stored in the LRU register 619.

Next, at Step S410, a real address register set setting unit in the processor 1 determines which of N sets of the real address register sets 620 to update based on the read value in the LRU register 619. Thereafter, a store instruction is issued to the three registers 621 to 623 in the real address register set 620 in the real address space corresponding to the same number. That is, the real address register set setting unit in the processor 1 invalidates the real address register set 620 corresponding to the read number in the LRU register 619 and sets the real address space corresponding to the real address RA corresponding to the access request to the main memory 2 at Step S401 to the above-described invalidated real address register set 620. The hypervisor can easily designate the number of the register by just adding the number to the virtual address VA of the store instruction. This control makes it possible to avoid the problem of updating the registers of the wrong real address register set 620. Incidentally, the reading of the LRU register 619 can be processed for a very short period of time as compared to the time taken for the replacement of the real address spaces, so that a penalty for the reading of the LRU register 619 is negligible.

As described above, in the hardware table walker 602 with out-of-order execution, it is possible to efficiently perform the replacement of the real address spaces, conceal a very large penalty for which the necessary real address spaces are replaced frequently, drastically decrease the processing time, and improve the performance.

FIG. 6 is a diagram depicting a configuration example of the processor 1 including the hardware table walker 602. Hereinafter, the portion of the processor 1 in FIG. 6 added to the processor 1 in FIG. 1 will be explained. The hardware table walker 602 includes: a plurality of request reception units 611; a plurality of request control units 612; a control set register 613; a TSB pointer calculation unit 614; a control unit 615; and the LRU register 619. The control set register 613 includes the real address register set 620. The real address register set 620 includes; the lower limit real address register 621; the upper limit real address register 622; and the offset register 623. The control unit 615 includes: a TSB hit check section 616; s real address range check section 617; and an offset addition section 618.

At Step S402, a TLB control unit 601, in the case of a TLB miss, outputs a TLB miss to the request reception units 611 to activate the hardware table walker 602. The plural request reception units 611 receive a plurality of thread requests from the TLB control unit 601. The plural request control units 612 execute the plural requests corresponding to the plural request reception units 611 in an out-of-order manner. That is, the hardware table walker 602 operates with out-of-order execution. The request control unit 612 stores address translation pairs TSB1 to TSB4 in the TSB area 3, for example to control the control set register 613. The TSB pointer calculation unit 614 calculates a TSB pointer pointing a TSB prefetch address based on the requested virtual address VA to output the calculated TSB pointer to the L1 caches 15 and 16.

The TSB hit check section 616, at Step S405, checks whether or not a TSB hit has been made. The real address range check section 617, at Step S405, checks whether or not the requested real address RA falls within the range of the real address space based on the real address register set 620. The offset addition section 618 adds the offset address of the offset register 623 to the real address RA to thereby arithmetically operate the physical address PA. Thereafter, the control unit 615 outputs the address translation pair of the virtual address VA and the physical address PA to the TLB control unit 601. The TLB control unit 601 registers the address translation pair in the address translation buffer 20. Further, when a TSB hit is made, the control unit 615 updates the LRU register 619.

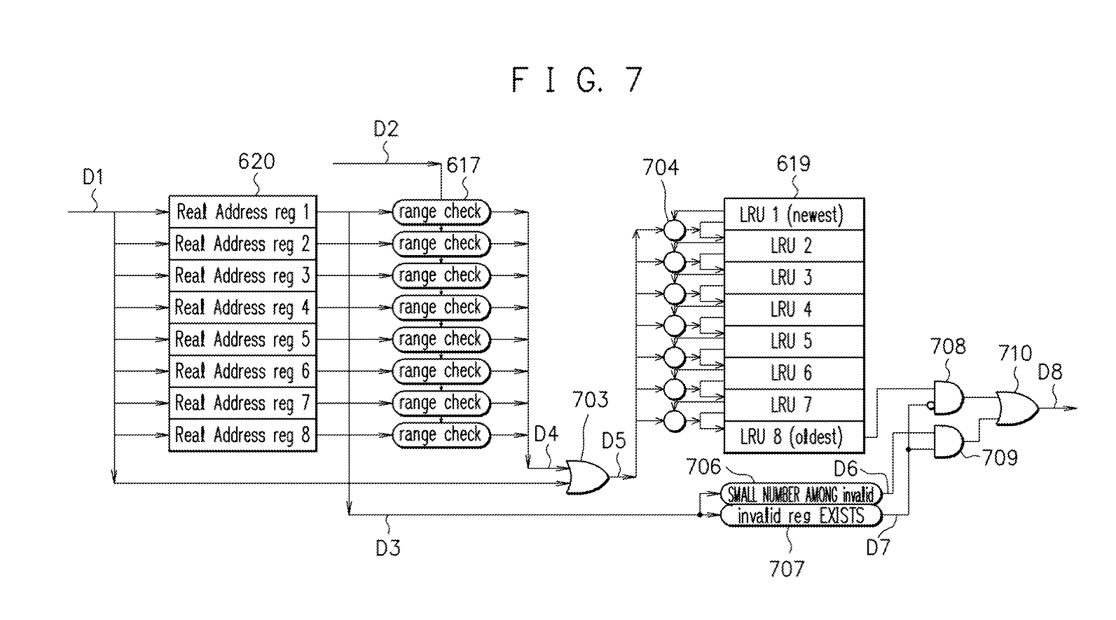

FIG. 7 is a diagram depicting a specific configuration example of a part of the hardware table walker 602 in FIG. 6. The hardware table walker 602 includes, for example, eight sets of the real address register sets 620 and the eight real address range check sections 617.

The hypervisor executes the update of the real address register sets 620 by a store instruction, and an update signal (update ID) D1 is input to the real address register sets 620. The LRU register 619 includes eight resisters LRU1 to LRU8. The resisters LRU1 to LRU8 store the numbers of eight sets of the real address register sets 620. The register LRU1 stores the number corresponding to the real address register set 620 being the latest in the use history. The register LRU8 stores the number corresponding to the real address register set 620 being the oldest in the use history, and stores the number corresponding to the real address register set 620 to be a candidate when the real address register set 620 is updated next. Further, each of eight sets of the real address register sets 620 stores a valid flag D3. When the valid flag D3 is one, the contents of the real address register set 620 corresponding to the valid flag D3 being one are indicated to be valid. When the valid flag D3 of “0” is included in the eight valid flags D3, a valid flag processing unit 707 outputs an invalid flag D7 of “1”, and when the eight valid flags D3 are all “1,” the valid flag processing unit 707 outputs the invalid flag D7 of “0.” A small number processing unit 706 outputs the number of the real address register set 620 corresponding to the smallest number of the numbers of the real address register sets 620 each storing the valid flag D3 of “0” as a number D6. Incidentally, the number D6 is not necessary to be a small number, and is only necessary to an arbitrary single number. A logical product circuit 708 outputs zero when the invalid flag D7 is “1.” A logical product circuit 709 outputs the number D6 when the invalid flag D7 is “1.” In the case, a logical sum (OR) circuit 710 outputs the number D6 as a number D8, and at Step S502, the number D8 is read. That is, in the case of the invalid flag D7 being “1,” the real address register set 620 corresponding to the number D8 becomes a candidate when the real address register set 620 is updated next.

Next, an update method of the LRU register 619 will be explained. As the update condition, the case when any one of eight sets of the real address register sets 620 has been updated, and the case when the hardware table walker 602 registers the address translation pair fetched from the TSB area 3 in the address translation buffer 20 are set. When any one of eight sets of the real address register sets 620 has been updated, a logical sum circuit 703 outputs a number D1 of the updated real address register set 620 as a number D5. Further, when the hardware table walker 602 registers the address translation pair fetched from the TSB area 3 in the address translation buffer 20, the eight real address range check sections 617 each output a number D4 of the real address register set 620 in the real address space including a real address D2 of the above-described address translation pair to the logical sum circuit 703, and the logical sum circuit 703 outputs the number D4 as the number D5.

The number D5 indicates the number of the real address register set 620 that has been updated most recently or the number of the real address register set 620 that has been used in the hardware table walker 602 most recently, and is stored in the register LRU1. At this time, when the numbers stored in the registers LRU1 to LRU8 and the number D5 are compared and are matched, in the registers LRU1 to LRU8 corresponding to the numbers smaller than that stored in the register corresponding to the matched number, the numbers stored in the registers LRU1 to LRU8 respectively are shifted to the registers LRU1 to LRU8 corresponding to the numbers one larger than the numbers that have been stored by shift units 704. For example, when the number D5 matches the number stored in the register LRU4, the number stored in the register LRU3 is stored in the register LRU4, the number stored in the register LRU2 is stored in the register LRU3, the number stored in the register LRU1 is stored in the register LRU2, and the number D5 is stored in the register LRU1. In this manner, the number of the real address register set 620 that has not been used is shifted to the register LRU8. When the invalid flag D7 is “0,” the logical product circuit 708 outputs the number stored in the register LRU8. When the invalid flag D7 is “0,” the logical product circuit 709 outputs zero. In the case, the logical sum circuit 710 outputs the number stored in the register LRU8 as a number D8, and at Step S502, the number D8 stored in the register LRU8 is read. That is, in the case of the invalid flag D7 being “0,” the real address register set 620 corresponding to the number D8 stored in the register LRU8 becomes a candidate when the real address register set 620 is updated next.

The number D8 output by the logical sum circuit 710 is designed so as to be read by the hypervisor. Thereby, the hypervisor can acquire the number of the real address register set 620 being the oldest in the use history of eight sets of the real address register sets 620. It is possible for the hypervisor to, by using this number, determine the real address register set 620 to be updated next and execute a store instruction to update the desired real address register set 620.

According to this embodiment, the replacement of the real address spaces is efficiently performed by using the LRU register 619, thereby making it possible to prevent the frequently-used real address space from being replaced and to decrease the processing time.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor connected to a storage device including a buffer area where an address translation pair of which a virtual address and a real address are made to correspond is stored, the processor comprising:
a real address register set that comprises a plurality of real address registers comprising: a lower limit real address register holding a lower limit real address of a plurality of real address spaces set in the storage device; and an upper limit real address register holding an upper limit real address of the plurality of real address spaces and holding a real address;
an LRU register that holds a number of the real address register being the oldest in a use history of the plurality of real address registers;
a reading unit that reads the number of the real address register held in the LRU register when a real address included in an access request to the storage device does not fall within a range of a real address space from the lower limit real address held in the lower limit real address register to the upper limit real address held in the upper limit real address register; and
a setting unit that invalidates the real address register corresponding to the read number and sets a real address space corresponding to the real address included in the access request to the invalided real address register.

2. The processor according to claim 1, further comprising:
an update unit that updates the number held in the LRU register so that when the real address included in the access request falls within the range of the real address space from the lower limit real address held in the lower limit real address register to the upper limit real address held in the upper limit real address register, a use history of the real address register holding the real address falling within the range of the real address space becomes the latest.

3. The processor according to claim 1, further comprising:
an address translation buffer that stores an address translation pair of which a virtual address and a physical address are made to correspond;
a cache memory that stores a part of information stored in the storage device; and
an access unit that, when an address translation pair including a virtual address included in the access request is stored in the address translation buffer, accesses the cache memory using a physical address translated according to the address translation pair, wherein
the reading unit reads the number stored in the LRU register when the address translation pair including the virtual address included in the access request does not exist in the buffer area.

4. The processor according to claim 3, further comprising:
a register unit that, when the real address included in the access request falls within the range from the lower limit real address held in the lower limit real address register to the upper limit real address held in the upper limit real address register, registers in the address translation buffer, an address translation pair including a physical address generated based on the address translation pair in the buffer area corresponding to the real address.

5. The processor according to claim 4, wherein
the real address register set comprises an offset register that stores an offset address by which a real address is translated into a physical address, and
the register unit generates the physical address by adding the offset address to the real address included in the access request.

6. A control method of a processor connected to a storage device including a buffer area where an address translation pair of which a virtual address and a real address are made to correspond is stored and comprising: a real address register set that comprises: a lower limit real address register holding a lower limit real address of a plurality of real address spaces set in the storage device; and an upper limit real address register holding an upper limit real address of the plurality of real address spaces; and an LRU register that holds a number of, of a plurality of real address registers, the real address register being the oldest in a use history; the control method comprising:
reading the number of the real address register held in the LRU register when a real address included in an access request to the storage device does not fall within a range of a real address space from the lower limit real address held in the lower limit real address register to the upper limit real address held in the upper limit real address register in a reading unit included in the processor;
invalidating the real address register corresponding to the read number in a setting unit included in the processor; and
setting a real address space corresponding to the real address included in the access request to the invalided real address register in the setting unit.
